(19) United States
(12) Patent Application Publication
(10) Pub. No.: US 2016/0241499 A1
(43) Pub. Date: Aug. 18, 2016

(54) DELIVERING AN EMAIL ATTACHMENT AS A SUMMARY

(71) Applicant: HEWLETT PACKARD ENTERPRISE DEVELOPMENT LP, Houston, TX (US)

(72) Inventors: Joshua Hailpern, Sunnyvale, CA (US); Sitaram Asur, Palo Alto, CA (US)

(73) Assignee: Hewlett Packard Enterprise Development LP, Houston, TX (US)

(21) Appl. No.: 15/025,693

(22) PCT Filed: Sep. 30, 2013
(86) PCT No.: PCT/US2013/062569

§ 371 Date: Mar. 29, 2016

(51) Int. Cl. H04L 12/58

(52) U.S. Cl. CPC H04L 51/08; H04L 51/063

(57) ABSTRACT

Delivery of an attachment as a summary in an email is disclosed. An attachment in an email to be sent by a sender is summarized to extract attachment highlights. The email is sent from the sender to a recipient by including in a body of the email the extracted attachment highlights and a link to the attachment.

### BACKGROUND

Electronic mail (or email for short) has become a primary method of communication for people within and beyond enterprises. It is estimated that over 100 billion emails are exchanged worldwide per day and that over 20% of an employee's work week is spent on email. Despite the proliferation of social networking communities and other communication tools, email continues to dominate enterprise communications. While email communication is empowering and has changed workplace habits, the large amounts of email sent to employees per day has led to a poverty of attention. As emails become more abundant, the users' ability to process them becomes increasingly constrained.

Email overload is a well-established problem, with many emails vying for a user's attention based on information, personal utility and task importance. The content of the emails can further exacerbate email overload, in particular when emails are accompanied by attachments. Attachments are files (e.g., documents, slides, etc.) that are sent along with an email to supplement the email's content, or as the main/informational content. These files can be large (multiple megabytes), lengthy (multiple pages), and not optimized for smaller screen sizes, limited reading time, or expensive bandwidth of mobile users. Thus, attachments can increase data storage costs (for both end users and email servers), drain users' time when irrelevant, cause important information to be missed if ignored, and pose a serious access issue for mobile users.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of an environment where the email management system is used in accordance with various examples;

FIG. 2 illustrates examples of physical and logical components for implementing the email management system;

FIG. 3 is a flowchart of example operations of the mail management system of FIG. 2 for delivering an attachment as a summary;

FIG. 4 is an example summarization algorithm for summarizing an attachment document with attachment highlights;

FIG. 5 is another example summarization algorithm for summarizing an attachment document with attachment highlights;

FIG. 6 is yet another example summarization algorithm for summarizing an attachment document with attachment highlights;

FIGS. 7A-B illustrate evaluation results for comparing the summarization algorithms of FIGS. 4-6; and

FIG. 8 shows storage consumption of attachment files used during the evaluation of algorithms of FIGS. 4-6.

### DETAILED DESCRIPTION

An email management system for summarizing the content of email attachments is disclosed. The email management system summarizes an attachment in an email to be sent by a sender to extract attachment highlights. The email is sent to a recipient by including the extracted attachment highlights and a link to the attachment in the body of the email. The attachment itself is not included in the email, thereby reducing file storage costs and bandwidth consumption. As generally described herein, an attachment is a file (e.g., document, images, videos, slides, etc.) or a link to a file or website that is sent along with an email to supplement the email's content, or as the main/only informational content.

In various examples, the email management system is implemented in a client/server architecture with the client having an email attachment detection module, and the server having an email attachment summarization module and an email delivery module. The email attachment detection module detects whether a user intends to send an email with an attachment and asks the user whether (e.g., via a pop-up window) the email can be sent using the summarization feature of the email management system. If so, the email attachment detection module sends the email, the attachment email metadata and email signature to the server for summarization and email delivery. The email attachment summarization module summarizes the attachment to extract its highlights. In the case of an attachment being a link to a file or a website, the contents of the file or website are summarized. As generally described herein, the attachment highlights are concept sentences representative of the content in the attachment. The email delivery module then sends the email to a recipient by including the attachment highlights and a link to the attachment (and not the attachment itself) in the body of the email.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

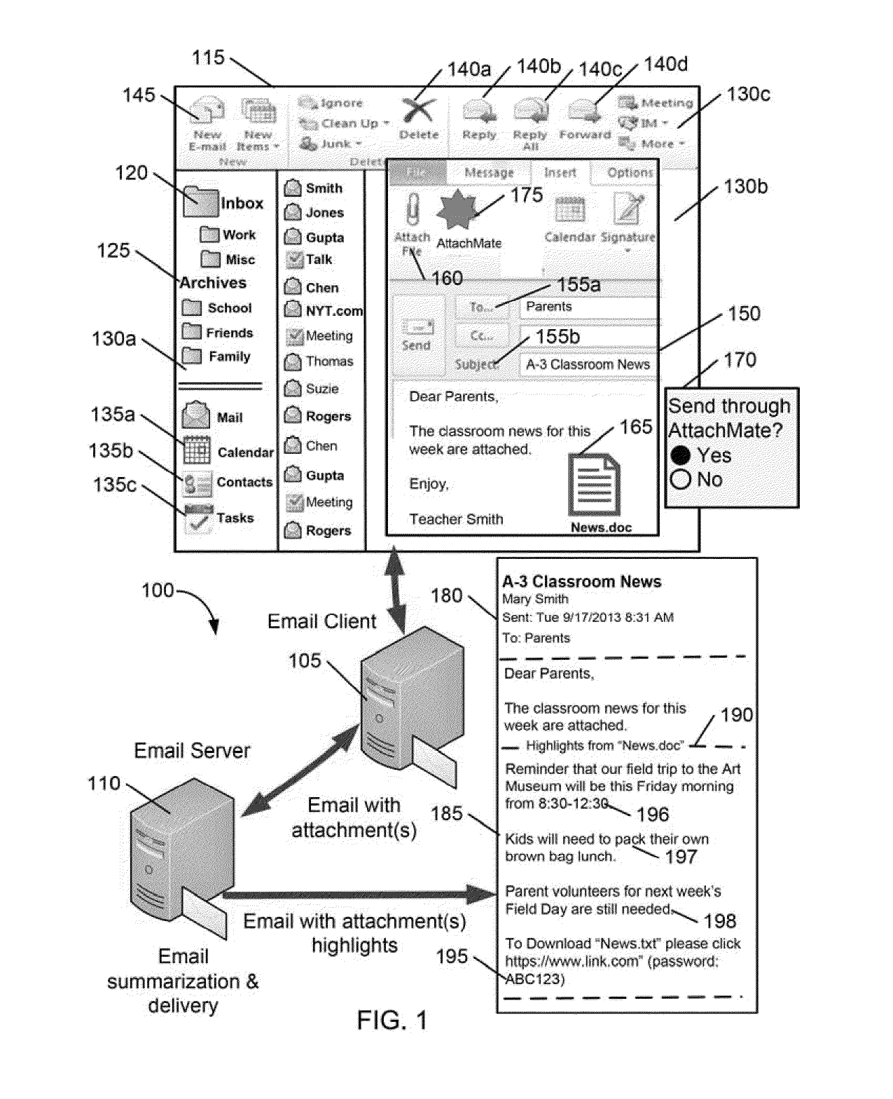

Referring now to FIG. 1, a schematic diagram of an environment where the email management system is used in accordance with various examples is described. Email management system 100 is implemented in a client/server architecture with an email client 105 and an email server 110. The email client 105 may be a plug-in, add-in or extension to a user's email system 115 (e.g., Microsoft® Outlook, Pine, IBM Notes, etc.). The email system 115 has an inbox 120 for a user to receive emails from various parties and entities. The emails may be copied or moved to different folders (e.g., archives folders 125), enabling the user to manage his/her email intake/outtake. The email system 115 may be organized in different visual areas, such as a navigation pane 130a for the user to navigate through different folders and tools (e.g., calendar tool 135a, contacts tool 135b, and tasks tool 135c), a reading pane 130b for the user to see a list of emails in the inbox 120 and the content of an email in the list, and an actions pane 130c listing tasks that a user may perform on an email, such as, a delete task 140a, a reply task 140b, a reply-all task 140c, and a forward task 140d.

Users can send an email by clicking on “New E-mail” icon 145. Clicking on icon 145 will open up a pop-up window 150 with e-mail fields for the user to fill out, including a “To” field 155a to list a recipient(s) for the email and a “Subject” field 155b for the user to insert a subject line descriptor for the email. The user can also click on an “Attach File” icon 160 in the pop-up window 150 to insert attachment(s) to the email, such as, for example, attachment 165. Upon clicking on icon 160, the email client 105 opens up a pop-up window 170 to ask the user whether the user wants to use the email management system (referred to in FIG. 1 as “AttachMate”) to send the email. Alternatively, instead of clicking on icon 160, the email system 115 can have a direct option to AttachMate with icon 175. Clicking icon 175 will bypass pop-up window 170 so the email can be sent automatically with attachment highlights and a link to the attachment(s) rather than the attachment itself.

When the user decides to send the email using the email management system 100 either by clicking on icon 160 and answering “yes” on pop-up window 170, or by clicking on icon 175, the email client 105 sends the email content, metadata, signature (if any), and the attachment(s) 165 to the email server 110. The email server 110 stores the attachment(s) 165 in a cloud-based network (not shown). Every file stored by the server 110 in the cloud-based network may be checked against any other files (e.g., via hash) to determine if the file is redundant. This further reduces storage costs as the attachment(s) 165 are not themselves stored in the server 110. The server 110 then creates a unique URL for each attachment file and a randomly generated password to protect access to the attachment files. As described in more detail below, the attachment(s) 165 is then summarized to extract attachment highlights. The attachment highlights are concept sentences representative of the content in the attachment, e.g. representative sentences 196-198.

The server 110 delivers the email 180 with the attachment highlights 185 to the recipient. In various examples, visual delineation of the attachment highlights 185 (e.g., with a line 190) is included into the body of email 180 so that the recipient can easily find the break points between the email highlights 185 and the content of the email 180. The URL to the attachment(s) 165 and the password 195 for accessing it in the cloud-based network are also included in the email 180.

Subsequently, the email recipient's mailbox never receives the attachment(s) 165 themselves as the attachment(s) 165 are only transferred once (i.e., from email client 105 to email server 110). Downloads are therefore only executed by explicit user request. Overall, this reduces storage costs, network costs, and access speeds as files are only ever stored once, and not replicated across multiple exchange server mailboxes or local caches. In addition, when emails are replied to or forwarded, the links and passwords allows attachments to be shared (with summaries), but the files remain on the server 110 (further reducing bandwidth and storage). Lastly, attachment storage on the server 110 is further optimized by keeping only one copy of each unique file (though distinct URLs and passwords are generated so each sent attachment appears to be unique). Thus, redundant attachments are only stored once.

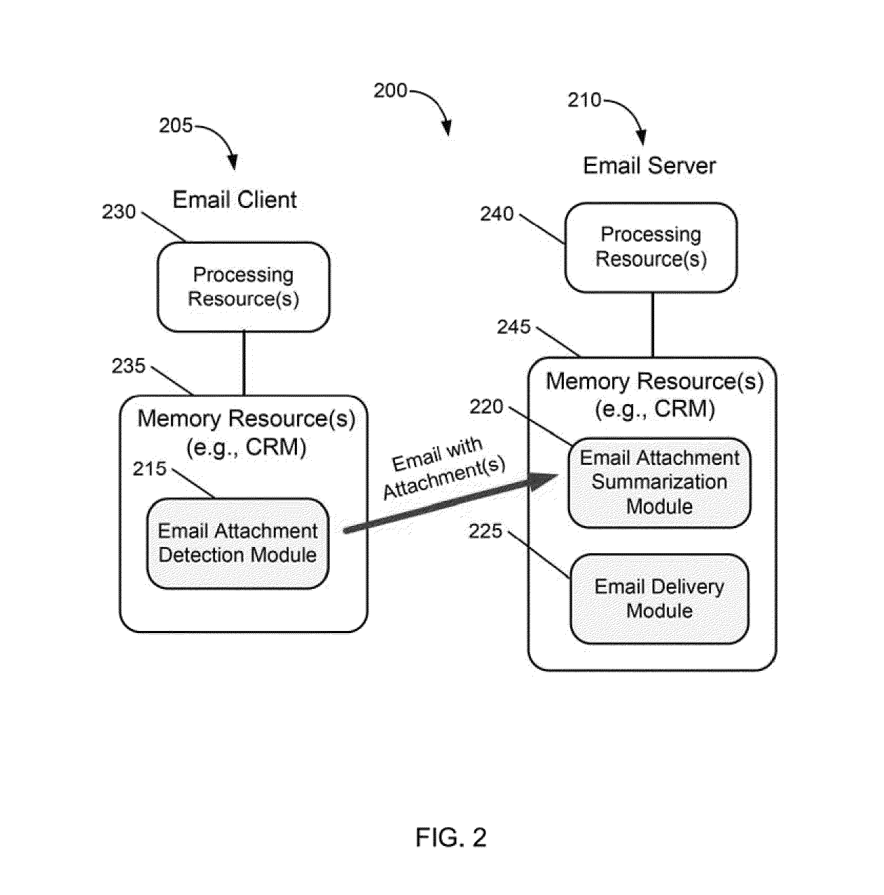

Attention is now directed to FIG. 2, which shows examples of physical and logical components for implementing the email management system. The email management system 200 is implemented in a client/server architecture with a client 205 and a server 210. The client 205 and the server 210 have various modules, including, but not limited to, an Email Attachment Detection Module 215 in client 205, an Email Attachment Summarization Module 220 in server 210 and an Email Delivery Module 225 in server 210. In an example implementation, modules 215-225 may be implemented as instructions executable by one or more processing resource(s) (e.g., processing resource 230 in client 205 and processing resource 240 in server 210) and stored on one or more memory resources) (e.g., memory resource 235 in client 205 and memory resource 245 in server 210). The email client 205 can be installed by the user as a plug-in to an email system (e.g., Microsoft® Outlook, Pine, IBM Notes, etc.).

A memory resource, as generally described herein, can include any number of memory components capable of storing instructions that can be executed by a processing resource(s), such as a non-transitory computer readable medium. It is appreciated that memory resource(s) 235 and 245 may be integrated in a single device or distributed across multiple devices. Further, memory resource(s) 235 and 245 may be fully or partially integrated in the same device (e.g., a server device) as their corresponding processing resource(s) (e.g., processing resource 230 for memory resource 235 and processing resource 240 for memory resource 245) or it may be separate from but accessible to their corresponding processing resource(s).

Email Attachment Detection Module 215 detects whether a user intends to send an email with an attachment and asks the user whether (e.g., via a pop-up window) the email can be sent using the summarization feature of the email management system 200. If so, the Email Attachment Detection Module 215 sends the email, the attachment, email metadata, and email signature to the server 210 for summarization and email delivery. The Email Attachment Summarization Module 220 summarizes the attachment to extract its highlights. The Email Delivery Module 225 sends the email to a recipient by including the attachment highlights and a link to the attachment (and not the attachment itself) in the body of the email.

It is noted that the Email Summarization Module 220 can provide a preview mode of an attachment so that when the attachment needs to be summarized, a summary preview can be shown to the email senders. This allows users to further refine and improve summaries by allowing users to see the “top N” highlights (as determined by the summarization algorithm) and approve or replace sentences as desired.

It is also noted that the Email Summarization Module 220 can be implemented as part of the user's email system (e.g., Microsoft® Outlook, Pine, IBM Notes, etc.) or on a server that serves as an email server for a web-based email application. Further, it is noted that client 205 may be a desktop or a mobile client. Email management system 200 may also be implemented as a mobile application on a user's mobile device. Since mobile users suffer from limited screen space, the email management system 200 may be adapted to have a mobile default option that summarizes all attachments sent to mobile users. Attachments sent to desktop users may be left intact or summarized as desired.

In addition, the email management system 200 can be adapted to determine whether to summarize an attachment based on how much storage space is available for the user. For example, if the user has plenty of storage in his/her email server, the email management system 200 may be able to send the attachment document to the user in full. Otherwise, if storage is limited, the email management system 200 can include the attachment highlights and a link to the attachment in the emails as described above. The attachments may also be stored as part of a file hosting service, such as, for example, Dropbox.

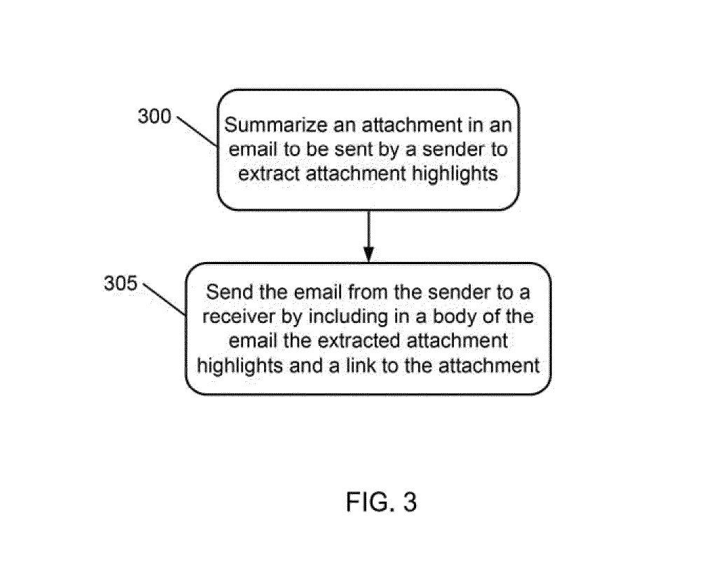

The operation of email management system 200 is now described in detail. Referring to FIG. 3, a flowchart of example operations of the email management system of FIG. 2 for delivering an attachment as a summary is described. First, the attachment is summarized to extract attachment highlights (300). Then the email is sent to a recipient by including in a body of the email the extracted attachment highlights and a link to the attachment (305). A password for accessing the attachment in a cloud-based network is also included.

It is appreciated that the key to having users adopt the email management system 200 to send emails with attachment highlights rather than including the attachment in the email is a robust summarization of the attachment document. Having a good and automatic summarization algorithm gives the users confidence that the attachment highlights will be a good representation of the attachment document. Automatic summarization is the process by which a description of a document or collections of documents is generated by a computer algorithm. In the case of attachments, summarization should consider the fact that the attachments may contain unstructured data and be of unknown length (as attachments can be very short or very log).

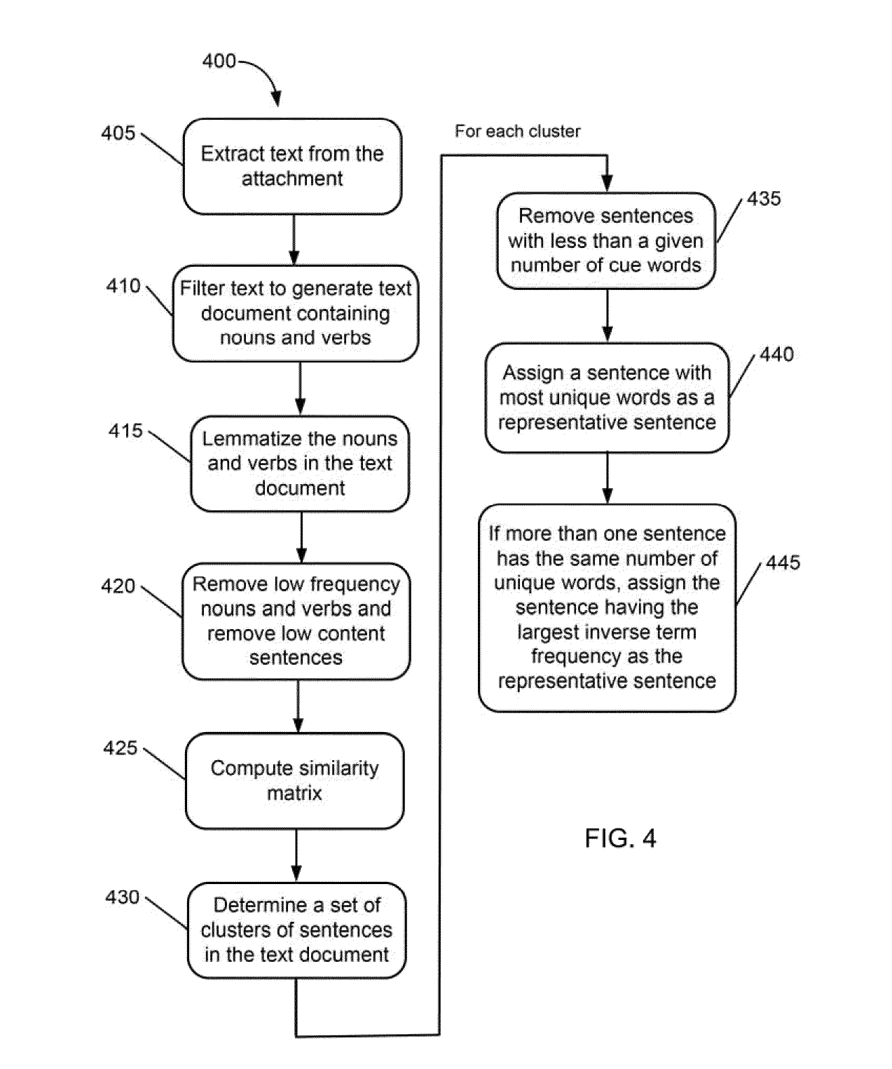

Example summarization algorithms that may be used to summarize attachments in emails with attachment highlights are described below with reference to FIGS. 4-6. The goal is provide a given number (e.g., a number higher than 1, such as 3, 5, 10, etc.) of representative sentences to summarize the content of an attachment document. By showing more than a single sentence to summarize the contents of an attachment document, users can get a broader view of the content and decide whether the attachment document needs to be opened (i.e., by clicking on the link to the attachment document provided in the body of the email) to be read in full. This is especially necessary for mobile users where the time and effort required to read an attachment is much higher. In addition, not every document has one “perfect” sentence that covers all of its content.

Referring now to FIG. 4, an example summarization algorithm for summarizing an attachment document with attachment highlights is described. Summarization algorithm 400, referred to herein as the Word Distance Based Clustering (“WDBC”) algorithm, adapts the principles of summarization techniques for long, well-structured documents to single documents of unknown length and undefined, or nonexistent structure. There are four main approaches for the selection of representative sentences within long and structured documents: (1) a thematic (semantic) approach for selecting representative sentences based on the meaning or content of the words; (2) a location-based approach for selecting representative sentences based on the relative or absolute location (physical placement) between words, sentences, or paragraphs; (3) a structure-based approach for selecting representative sentences based on explicit structural elements of the documents (e.g., section headings and titles); and (4) a cue phrase-based approach that selects representative sentences based on a probability of a sentence being relevant according to the presence of pragmatic, cue words from a dictionary (e.g., “above all”, “notably”, “unfortunately”, etc.) in the sentence.

The WDBC summarization algorithm 400 focuses on integrating the thematic and cue phrase-based approaches and adapting them to unstructured, single attachment documents. The first step is to extract all the text from the attachment document to be summarized (405). The text is filtered to generate a text document from the attachment document containing information heavy (i.e., nouns and verbs) words (410). The text document is then lemmatized (i.e., the different inflected forms of words in the document are grouped together so they can be analyzed as a single item) to eliminate plurals, multiple verb tenses and conjugations (415). Next, all low frequency words and low content sentences are removed from the text document (420). A word is considered low frequency if it occurs less than 3 times in the text document or if its frequency divided by the total word count is less than 20%. A sentence is considered low content if it has less than 3 information heavy (i.e., nouns and verbs) words.

Once the text document has been filtered and streamlined to include meaningful words and sentences, the WDBC algorithm 400 proceeds to identify representative clusters and representative sentences within the clusters. First, a similarity matrix of sentences is computed by calculating the average of pairwise distances between words for any two given sentences (425). That is, the matrix contains sentence pairs in its rows and columns, and averages of pairwise distances as the matrix values. The pairwise distances can be calculated by, for example, using WordNet (which is a graph of words linked by weighted edges based on semantic similarity) to find the semantic distance between concepts.

With the similarity matrix computed, the WDBC algorithm 400 then determines a set of clusters of sentences in the text document by using k-means clustering (where k is the number of clusters, e.g., 3, 5, 10, etc.) (430). Then, for each cluster in the text document, the WDBC algorithm 400 proceeds to remove sentences with less than a given number (e.g., 2, 3) of cue worth (435). If there are no valid sentences, the number of cue words can be lowered (if still no sentences are left, then all sentences in the cluster are included). The sentence with the most unique words is assigned as the representative sentence for the cluster (440). If more than one sentence has the same number of unique words, the sentence having the largest inverse term frequency is selected as the representative sentence (445). Note that mere is one representative sentence for each cluster. The number of clusters can be changed as desired. To capture the attention of the email recipient without overwhelming him/her, three-five clusters and three-five representative sentences may be selected.

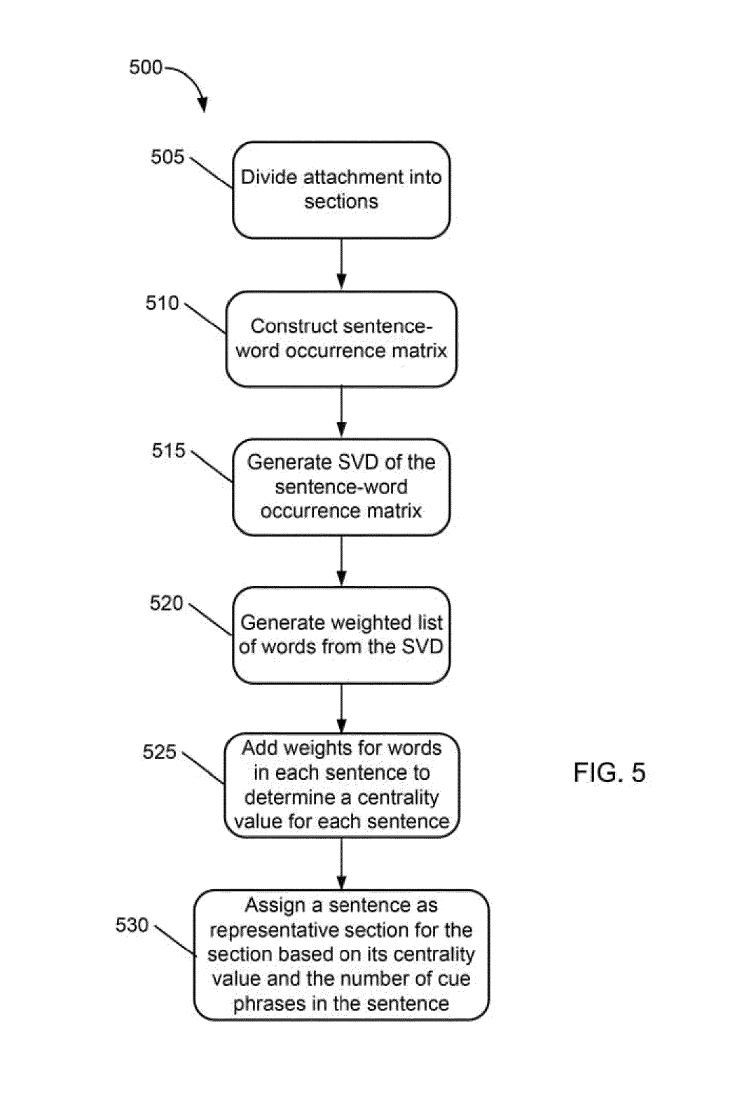

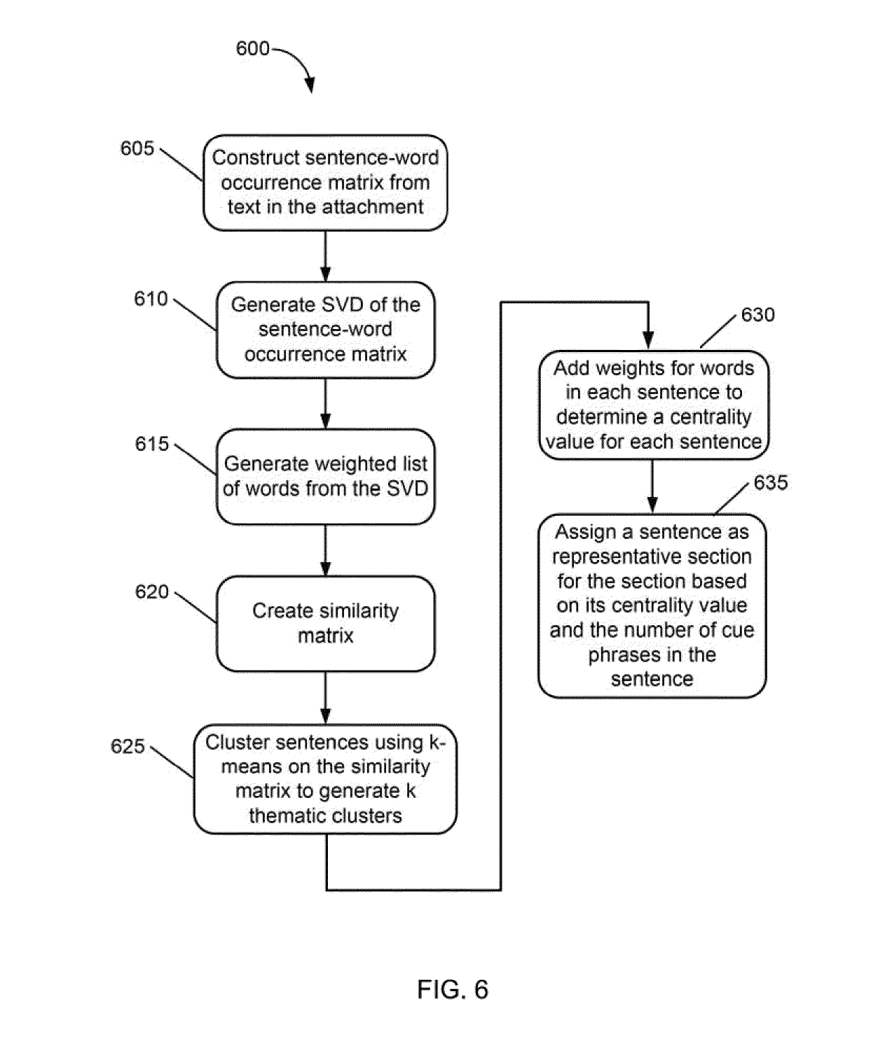

Although high performing, the WDBC algorithm 400 has a limitation in that the computation of the similarity matrix between sentences runs in O(n² log n) and does not scale. While the WDBC algorithm 400 runs in a matter of seconds on very short attachment documents, it may take around 5 minutes on a 10 page, text rich document. Faster approaches are presented next in FIGS. 5-6.

Attention is now directed to FIG. 5, which illustrates another example summarization algorithm for summarizing an attachment document with attachment highlights. Summarization algorithm 500, referred to herein as the Key Sentence by Thirds (“KSBT”) algorithm, is not based on semantic distances of information heavy words like the WDBC algorithm 400. Instead, the KSBT algorithm 500 divides each attachment document into sections (e.g., 3-5 sections), based on the physical location of each sentence (e.g., first third, middle third, last third). Doing so allows for an extremely fast summarization of an attachment document that leverages some sense of location. Further, the selection of representative sentences is streamlined within each section by using a proxy for semantic information based on Singular Value Decomposition (“SVD”), cue phrases and location.

First, the KSBT algorithm 500 divides the attachment document into sections (505). Next, a sentence-word occurrence matrix is constructed (which can be calculated in O(n)) with sentences as rows of the matrix, words as columns, and matrix values representing the number of occurrences of the words in the sentences (510). Next, a SVD is generated for the sentence-word occurrence matrix (515). The output of the SVD is used to calculate a weighted list of words, whose weight can be thought of as how “central” a word is to a document (a proxy for, though not exactly, semantic information (520)). The centrality of a sentence can then be calculated by adding the weights of the words for a given sentence (525).

The most representative sentence for each section is then selected by sorting all sentences based on their centrality value and the number of cue phrases in the sentences (530). The sentences are first sorted (with a centrality value>0 and cue phrases>0) by the number of cue phrases present. Ties are broken by the sentence with the smallest distance (in number of sentences) to the start or end of the document (whichever is smaller). If there are no cue phrases>0 or all sentences have the same centrality value, then the most representative sentence is selected by sorting all sentences by their centrality value and taking the one with the largest value. Likewise, if all sentences have the same centrality value (or are all 0), the sentence with the highest number of cue phrases is selected as the representative sentence.

At a conceptual level, the division of a document into sections based on their physical location may be considered to be arbitrary. Accordingly, another fast summarization approach may be used. Referring now to FIG. 6, another example summarization algorithm for summarizing an attachment document with attachment highlights is described. Summarization algorithm 600, referred to herein as SVD Based Distance and Clustering (“SBDC”) replaces the document division with a clustering that is potentially more representative of distinct thematic pairs. First, a sentence-word occurrence matrix is generated (605) and a SVD of the matrix is computed (610) to form a weighted list of words (615). Next, a similarity matrix of sentences is constructed for the top 500 words from the SVD (620). In this case, the value in each matrix cell is the cosine similarity between the vector representations of two given sentences. The vector representation of a sentence is the same as a row in the sentence-word occurrence matrix used in the KSBT algorithm 500, except that the weight for each word is from a SVD of the matrix so that more important words get more impact. Using this similarity matrix, the sentences are clustered using k-means into k (e.g., k=3) thematic clusters (625). The representative sentences for the clusters are then selected using the same approach of adding the weights for the words to determine a centrality value (630) and sorting the sentences based on their value and the number of cue phrases (635) as used in the KSBT algorithm 500 (steps 525 and 530).

It is noted that the KSBT algorithm 500 and the SBDC algorithm 600 both filter out non-information heavy words and lemmatize remaining words before summarizing the text from an attachment document. It is also noted that the KSBT algorithm 500 and the SBDC algorithm 600 both run faster and scale belter than the WDBC algorithm 400. An email management system 200 can therefore be deployed using any of these summarization algorithms depending on the performance and speed desired by the system.

An evaluation of the three algorithms 400-600 was conducted to test their performance as compared to two conventional, baseline approaches: (1) a commercially available summarization tool integrated with Microsoft® Word; and (2) a Cluster Center approach based on the known TextRank and LexRank algorithms. To generate a summary using Microsoft® Word, each attachment document was placed into a Microsoft® Word document. The internal summarize feature of Microsoft® Word was then used to produce three sentences, which were used as that document's highlights. For Cluster Center, k-means (with k=3) was used to discover three cluster centers resulting from clustering sentences into three “topic” clusters. A metric was defined to measure sentence distance, analogous to the word co-occurrence in TextRank. An information-theoretic definition of sentence distance was used to calculate the average of pairwise distance between words for any two given sentences in order to derive the three cluster centers.

Testing of the five algorithms (i.e., the two baseline Microsoft® Word and Cluster Center algorithms and the designed summarization algorithms 400-600) was conducted using Amazon® Mechanical Turk (“MT”) Human Intelligence Tasks (“HITs”) for a set of 20 documents. HITs were not grouped together so as to reduce order effects. An HIT consisted of the original source text, and the constructed summaries presented in random order. For each summary, participants were asked to respond to the statement “[T]he above three sentences give me a good overview of the article” with a 7-point Likert scale (Strongly Disagree (1) to Strongly Agree (7)).

Each HIT was completed by 20 Turkers, yielding 400 measures of quality per summary (4 documents across 5 subject areas). To ensure “legitimate” HIT completion, one “fake summary” was included with sentences extracted from other documents about different topics (e.g., a Science article having a summary from Sesame Street). These “fake summaries” were intended to be so outrageous that they would be ranked Strongly Disagree. If a Turker did not rate the “fake” summary as Strongly Disagree, then that response was thrown out and another HIT on the same document was posted to MT. An ANOVA and Student's T-test were used to compare the algorithms' performance. While performing multiple comparisons may suggest statistical adjustment to a more conservative value (i.e., Bonferroni correction), multiple thresholds of significance were highlighted. For transparency, t-test results and summary statistics were broken down by subject area.

It is noted that evaluating summarization algorithms presents a significant challenge, especially for large corpuses. This is mostly due to reviewers comparing the computer generated responses to their own mental images of an ideal human-generated summary. Therefore, receiving a perfect Strongly Agree is considered unlikely given the present standard of summarization tools.

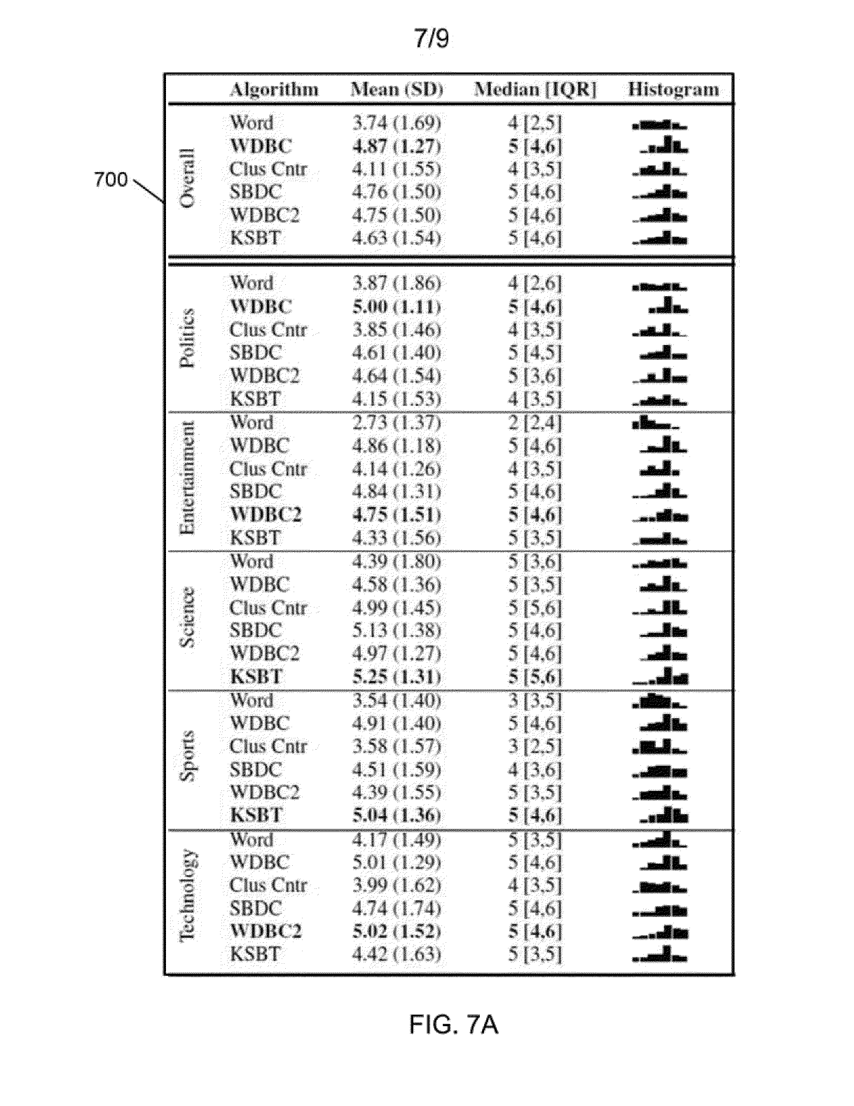

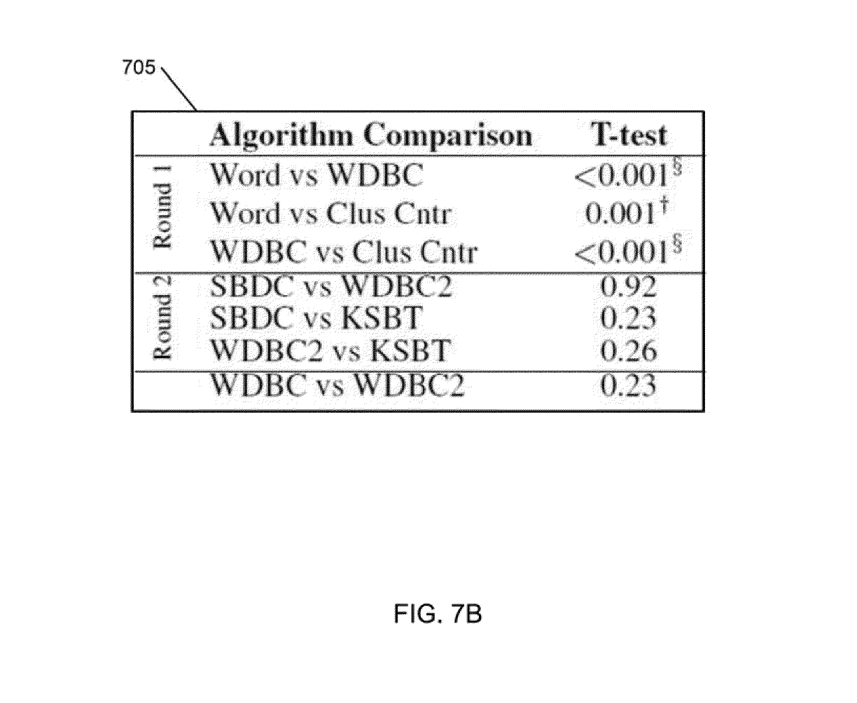

Master level Turkers were recruited to participate in the evaluation. Each completed HIT was paid 75 cents. 27 HITs were rejected for invalid responses to the “fake”summary. FIGS. 7A-B show the evaluation results. Table 700 in FIG. 7A includes the mean, median, and histograms of the distribution of MT responses. ANOVA comparing Microsoft® Word. WDBC 400 and Cluster Center resulted in p<0.001 (F=56.15). Comparative t-test outputs between each algorithm are reported in the first hall of Table 705 in FIG. 7B.

Overall WDBC 400 performed quite well with a median score of 5, and a mean of 4.87. It is notable that WDBC 400 statistically outperformed both Microsoft® Word and Cluster Center (the two baselines for comparison). In addition, when examining the histograms, inter quartile range and standard deviation, WDBC 400 was much tighter as compared to the other existing techniques. While not a perfect score on the 7-point scale, which is challenging (as detailed earlier), WDBC 400 is a stark and consistent improvement over the baseline approaches.

A second MT study was conducted to compare KSBT 500 and SBDC 600 with WDBC 400. Turkers were recruited with a 95% approval rate and a minimum of 1000 approved HITs. Each completed HIT was paid 50 cents. 67 HITs were rejected for invalid responses to the “fake” summary. The results of this study are shown in Table 700. ANOVA comparing WDBC 400 (WDBC2 in Table 700 as it was used as the baseline for comparison with KSBT 500 and SBDC 600), KSBT 500 and SBDC 600 resulted in p<0.43 (F=0.93), Comparative t-test output between each algorithm is reported in the second half of Table 705 to further highlight the lack of statistical difference found during the ANOVA.

In addition, the performance of WDBC 400 was compared in both experiments to see if the distribution of Turkers' responses are the same. The comparative T-test (Table 705) does not show statistical difference. However, because a lack of statistical difference does not mean statistical similarity, a similarity metric using a tolerance Θ in the means between the two data sets was computed. A conservative Θ was set to be one third of a Likert interval (0.333). This represents 1/18 (5.56%) of the possible answer range, and just 19.18% of the variance of WDBC 400 (σ²=1.74) and 14.82% of the variance of WDBC2 (σ²=2.25). The similarity test shows that WDBC and WDBC2 are statistically similar (p<0.05) as are WDBC2 vs. KSBT 500 and WDBC2 vs. SBDC 600. Both KSBT 500 and SBDC 600 appeal to have statistically equivalent performance to each other and WDBC 400. However, as mentioned above, KSBT 500 and SBDC 600 run faster and scale better than WDBC 400.

In order to test the value and usage of email management system 200, a real-world, ecologically valid study was conducted in an enterprise setting. For experimental purposes online, server 210 was adapted to log attachment download access attempts as well as the number of senders and receivers of email messages. Users' email addresses were not linked with the emails or attachments, and all activity was recorded using unique hashes of the sender's (and recipient's) email addresses. This enables the tracking of individual users, while maintaining the required privacy and anonymity within Company XYZ. The email management system 200 was deployed, and a broad invitation was sent out to all Company XYZ employees located in City ABC to which 51 responded by filling out a demographic survey. Of those, there were 41 unique downloads of client 205 for usage, and 27 unique senders of emails with system 200. Due to privacy concerns, it was not known which of the 51 respondents downloaded and used the client 205. All demographic information recorded was from the 51 respondents.

Once again, participation duration was left to the discretion of the individuals, though 5-10 business days of usage was encouraged. At the end of the study, a questionnaire was distributed to participants. This included Likert Scale, short answer, and SUS usability metric questions. Due to the privacy limitations, the survey was sent to all 51 respondents rather than directly to just those participants who downloaded and used system 200. This also limited the ability to follow up and ensure a high percentage of responses. Subsequently, only 6 responses were submitted (roughly 22% of unique senders). While this data may not be fully representative of all user experiences, results were presented from the survey to help inform and explain the observed behavior using system 200. In addition, due to the privacy concerns, no direct contact was established with recipients of emails from system 200 to determine their reaction.

Of the 51 individuals that responded to the survey, 54.9% were male. The average age was 40.99 (σ=10.43). The educational attainment, subject area and employment within Company XYZ was highly variable, representing a broad cross-section of the company. On average, participants used the system 200 for 7.30 days each (with a median use length of six days). There were 28 unique senders, and 67 unique receivers of emails. Because each email can be sent to multiple recipients, it is important to examine system 200 and the attachment usage from two distinct perspectives; those of the sender and of the recipient.

From the senders' perspective, 66 emails were sent using system 200, with a total of 105 attachments of which 73 were documents. Of these, 27.62% of the attachments and 38.36% of documents were downloaded. From the receivers' perspective, 93 emails were received, with a total of 155 attachments being received, 99 of which were documents. Only 18.71% of attachments and 38.28% of documents were downloaded. These relatively low attachment download rates are well under the average real-world rate of 65.5% of documents downloaded. This strongly suggests that system 200 summaries were highly beneficial in information presentation and document discrimination.

Supporting this, all participants mentioned the summarization of attachments to be the “best” feature of the system 200. When presented with the statement “Having Summaries is the key feature to system 200 being successful” and a 5-point Likert scale response, the average response was 4.6 (three participants marked 5 (strongly agree), two marked 4, and one marked 3). This is higher as compared to other features such as Summary Quality (4.33), Saving Bandwidth (4.25) and Mobile Access To Attachments (4.4). The only higher performing feature was Security of Files, to which all respondents reported 5 (Strongly Agree).

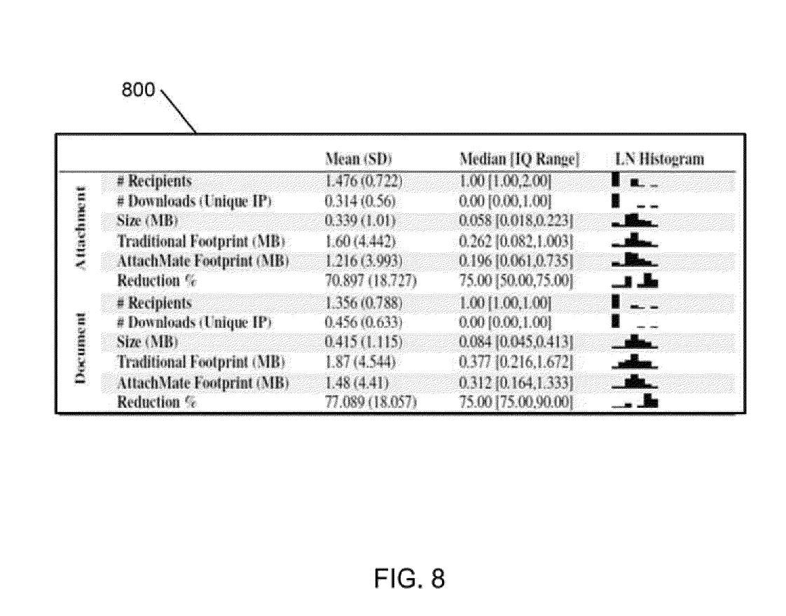

While system 200's summarization provides benefits for end users, its storage infrastructure provides financial benefits for their corporate employers. FIG. 8 shows the storage consumption for each file, normalized by user, in Table 800. On average, documents are just under half a Megabyte in size. However, when the multiple locations where the file is stored are considered (e.g., sender's local sent folder, sender's exchange sent folder, each receiver's server inbox, each receiver's local inbox), the average document footprint balloons to 1.87 Megabytes. However, with system 200's improved storage, this is reduced by 22.91% on a per file basis. Across all attachments, the reduction is larger, 29.10%. It should be noted that this is without any redundant file optimization (only storing one copy of a duplicate file) enabled. This feature was not used during the study because it can only show impact over a large, ongoing dataset and the current experiment was too short and limited in participants.

Overall, user responses suggested that system 200 reduces the data footprint of transferred documents by 22.91% and 29.10% for all attachments, while providing effective summaries. This is largely due to the provided summaries, which allow users to better triage which attachments need to be downloaded. The gains provided by the summaries can also be enjoyed by users receiving emails that had not yet been summarized. In this case, the receiving user requests a summary of the received attachment to be generated prior to the user reading the email.

It is appreciated that the previous description of the disclosed examples is provided to enable any person skilled in the an to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A computer implemented method for delivering an email attachment as a summary, comprising:
summarizing, by a computer, art attachment in an email to be sent by a sender to extract attachment highlights; and
sending, by a computer, the email from the sender to a recipient by including in a body of the email the extracted attachment highlights and a link to the attachment.

3. The computer implemented method of claim 1, wherein summarizing the attachment to extract attachment highlights comprises extracting text from the attachment and filtering the test to generate a text document containing noun words and verb words from the text.

4. The computer implemented method of claim 3, further comprising lemmatizing the noun words and verb words in the text document and removing low frequency noun words and verb words and low content sentences from the text document.

5. The computer implemented method of claim 4, further comprising computing a similarity matrix by calculating averages of pairwise distances between words for any two given sentences in the text document.

6. The computer implemented method of claim 5, further comprising determining a set of clusters of sentences in the text document.

7. The computer implemented method of claim 6, further comprising, for each cluster in the set of clusters:
removing sentences with less than a given number of cue words from the each cluster;
assigning a sentence with most unique words as a representative sentence for the each cluster; and
if more than one sentence has a same number of unique words, assigning a sentence having a largest inverse term frequency as the representative sentence.

8. The computer implemented method of claim 7, wherein including in a body of the email the extracted attachment highlights and a link to the attachment comprises including in the body of the email a representative sentence from each cluster and a password to access the attachment in the link to the attachment.

9. A system for delivering email attachments as a summary, comprising:
a processor; and
a set of memory resources storing a set of modules with routines executable by the processor, the set of modules comprising:
an email attachment summarization module to summarize an email attachment with attachment highlights; and
an email delivery module to send the email to a user by including in a body of the email the extracted attachment highlights and a link to the attachment.

10. The system of claim 9, wherein the attachment is not attached to the email and is accessed in a cloud-based network via the link with a password.

11. The system of claim 9, wherein the email attachment summarization module comprises routines to:
divide the attachment into sections;
construct a sentence-word occurrence matrix with words and sentences from the attachment;
generate a singular value decomposition of the sentence-word occurrence matrix;
generate a weighted list of words for the attachment from the singular value decomposition;
add weights for words in each sentence of the sentence-word occurrence matrix to determine a value for each sentence; and
assign a sentence as a representative sentence for the each section based on its value and a number of cue phrases in the sentence.

12. The system of claim 11, wherein the extracted attachment highlights comprise representative sentences from the sections in the attachment.

13. A non-transitory computer readable medium comprising instructions executable by a processor to:
detect an attachment in an email to be sent by a sender;
summarize the attachment to extract attachment highlights, the attachment highlights comprising representative sentences from a set of thematic clusters in the attachment; and
send the email from the sender to a receiver by including in a body of the email the extracted attachment highlights and a link to the attachment.

14. The non-transitory computer readable medium of claim 13, wherein the thematic clusters are generated by constructing a sentence-word occurrence matrix from text in the attachment and computing a singular value decomposition of the sentence-word occurrence matrix to generate a similarity matrix of sentences for extracting the thematic clusters.

15. The non-transitory computer readable medium of claim 13, wherein the email does not attach the attachment and the attachment is retrieved from a cloud-based network with an access password associated with the link to the attachment.
